(19) United States
(12) Patent Application Publication
(10) Pub. No.: US 2012/0056053 A1
(43) Pub. Date: Mar. 8, 2012

(54) FIXING MECHANISM

(76) Inventors: Tsung-Yin Wu, Taoyuan County (TW); Chao-Hsiung Wu, New Taipei City (TW)

(21) Appl. No.: 13/072,770

(22) Filed: Mar. 27, 2011

(30) Foreign Application Priority Data
Sep. 8, 2010 (TW) 099130300

(51) Int. Cl. F16B 2/02; F16M 13/02

(52) U.S. Cl. 248/224.8; 248/231.85; 248/229.2

(57) ABSTRACT

A fixing mechanism used to fasten an object on a case includes a clamping structure, a positioning pillar and a buffering structure. The clamping structure is provided with a through hole and connected to the object. The positioning pillar is connected to the case. The buffering structure is provided with a positioning hole and has a trench surrounding the buffering structure, and a plurality of protruding parts disposed on a sidewall of the positioning hole. The through hole of the clamping structure can be engaged with the trench, and the positioning pillar can be inserted into the positioning hole, so that the protruding parts and the positioning pillar engage with each other. Accordingly, the object can be fixed on the case.

### BACKGROUND OF THE INVENTION

1. Field of the Invention

The present invention generally relates to a fixing mechanism. In particular, the present invention relates to a fixing mechanism used to fasten an object to a case.

2. Description of the Prior Art

As technologies advance, more and more electronic devices, such as MP4 players, TVs, LCDs, mobile phones, PDAs and laptops, require equipped with speakers. Therefore, the electronic device provides not only high quality images, but also sounds from the speakers equipped therein so as to have media information containing both video and audio that can be simultaneously experienced.

Please refer to FIG. 1 and FIG. 2. FIG. 1 illustrates a conventional speaker, and FIG. 2 illustrates a conventional fixing mechanism. As shown in FIG. 1, a conventional speaker 10 has a substrate 12, which is a rectangular plate. As shown in FIG. 2, a conventional fixing mechanism 16 is made of two clamping structures 18, and each clamping structure 18 has a slot 20 and a plurality of ribs 22. Each slot has an opening 24, such that two openings 24 face each other. The ribs 22 are respectively disposed on the sidewalls inside the openings 24. The slot 20 and the ribs 22 extend from a case 14. The slot 20 and the ribs 22 are formed integrally with the case 14 so as to be fastened to the case 14.

Please refer to FIG. 3 with reference to FIG. 2. FIG. 3 illustrates a conventional speaker fastened to a conventional fixing mechanism. As shown in FIG. 2 and FIG. 3, the width d2 of the opening 24 of the slot 20 is substantially equal to the thickness d1 of the substrate 12, so that the substrate 12 can be inserted into the opening 24 of the slot 20, and the substrate 12 is fastened to the case 20 by the engagement of the ribs 22 in the opening 24. In addition, the length of the bottom of the opening 24 is substantially equal to the length of one side of the substrate 12, so that the substrate 12 can be fixed between the slots 20. In such a way, the conventional speaker 10 can be stably fastened to the case 14.

Generally speaking, vibration occurs when sounds come from the speaker 10 in operation. However, since the clamping structures 18 and the case 14 are formed integrally, they are made of plastic with certain rigidity and can not absorb the vibration easily. Accordingly, if the case is used as the case of an LCD, the vibration of the speaker also makes the speaker come off from the clamping structure easily. As a result, it is a goal in this field to provide a fixing mechanism to solve the problem of the speaker coming off from the clamping structure due to its vibration.

### SUMMARY OF THE INVENTION

For this reason, one of the aspects of the present invention proposes a fixing mechanism to solve the problem of the speaker coming off from the case due to its vibration.

The present invention provides a fixing mechanism, used to fasten an object on a case and the object has a first side and a second side. The fixing mechanism includes a first clamping structure, a first positioning pillar, a first buffering structure and a fixing structure. The first clamping structure is provided with a first through hole and connected to the first side of the object. The first positioning pillar is connected to the case. The first buffering structure is provided with a first positioning hole and has a first trench and a plurality of first protruding parts. The first trench surrounds a sidewall of the first buffering structure, so that the first through hole of the first clamping structure can be engaged with the first trench to fixate the first side of the object to the first buffering structure. The first positioning hole is disposed on a bottom surface of the first buffering structure, and a plurality of the first protruding parts are disposed on a sidewall of the first positioning hole, and the first positioning hole is used for engaging the first positioning pillar and the first protruding parts engage with the first positioning pillar, so that the first buffering structure is fixed to the first positioning pillar. The fixing structure is used for fastening the second side of the object on the case.

The present invention fixates a buffering structure made of a buffering material to at least one side of the object and forms a positioning hole disposed on a bottom surface of the buffering structure so that the positioning pillar on the case may be inserted into the positioning hole and fixates the buffering structure to the positioning pillar by means of some protruding parts. In such a way, the object is fixated to the case and if the object vibrates, the buffering structure absorbs the vibration coming from the object without passing it to the case, so the problem of resonance of the case is readily solved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a conventional speaker.

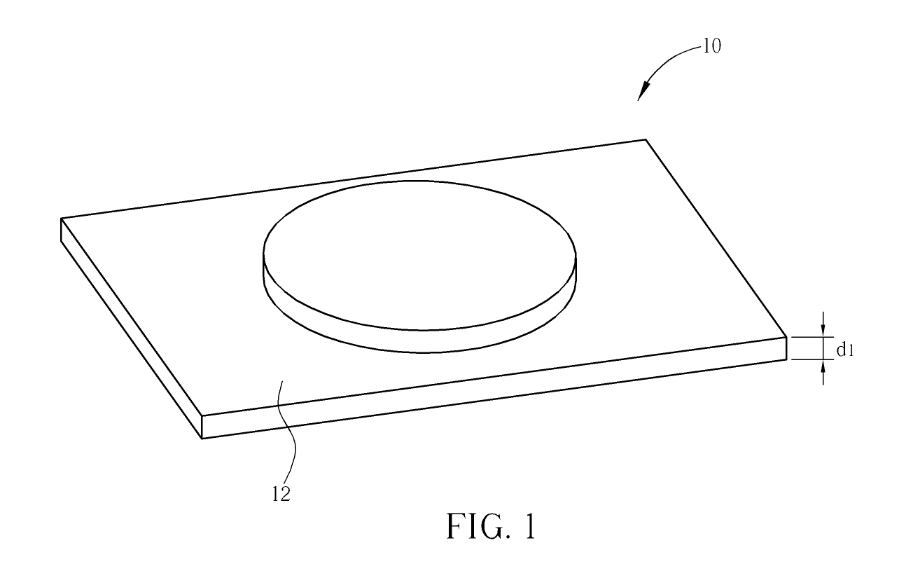

FIG. 2 illustrates a conventional fixing mechanism.

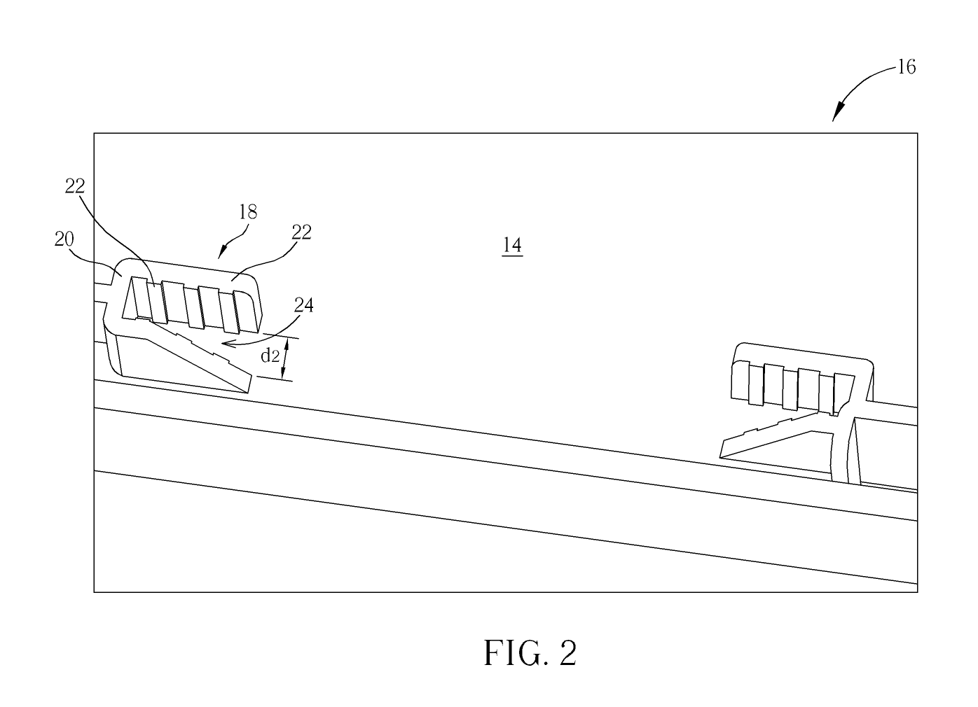

FIG. 3 illustrates a conventional speaker fastened to a conventional fixing mechanism.

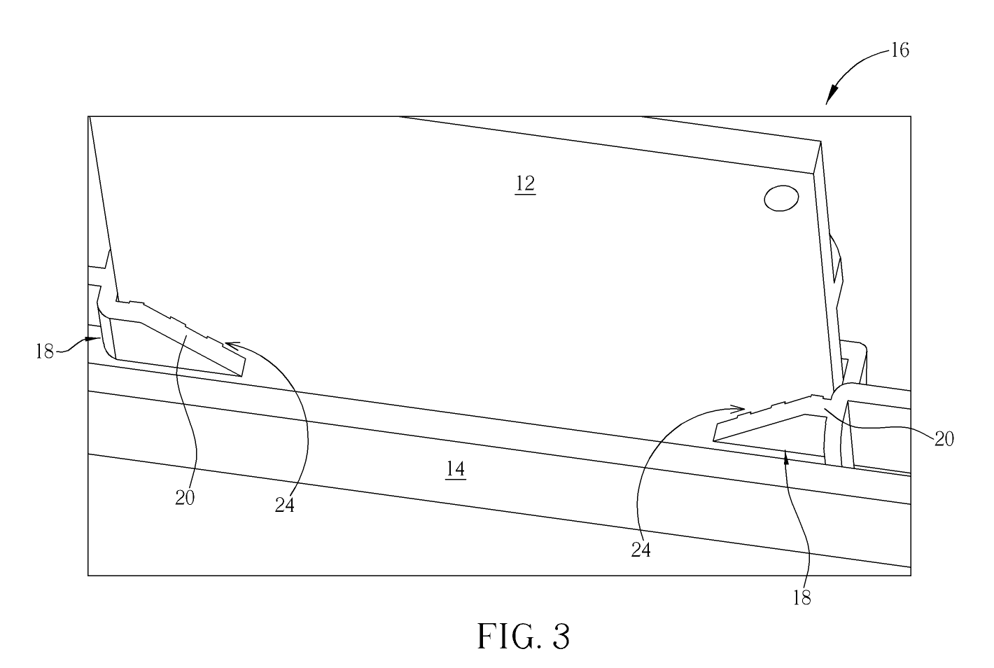

FIG. 4 illustrates a side view of the fixing mechanism according to a first embodiment of the present invention.

FIG. 5 illustrates a top view of the object with the first clamping structure and the second clamping structure of the first embodiment.

FIG. 6 illustrates a cross section of the first buffering structure of the first embodiment of the present invention.

FIG. 7 is a section view of the fixing mechanism in FIG. 4 along line A-A′.

FIG. 8 illustrates another example of the first buffering structure of the fixing mechanism of the first embodiment of the present invention.

FIG. 9 illustrates a side view of a fixing mechanism according to a second embodiment of the present invention.

### DETAILED DESCRIPTION

The fixing mechanism of the present invention is used to fasten an object onto a case. The case may be an electronic device displaying images, such as an MP4, TV, LCD, cell phone, PDAs or laptop, but it is not limited to these examples.

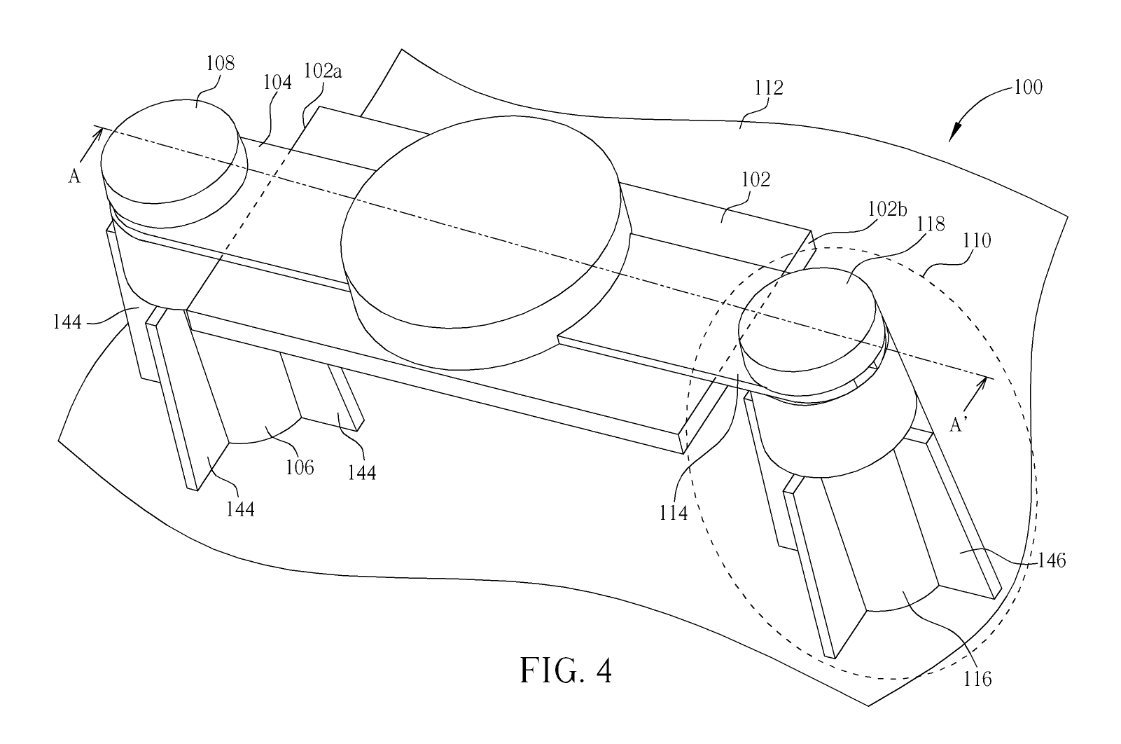

Please refer to FIG. 4. FIG. 4 illustrates a side view of the fixing mechanism according to a first embodiment of the present invention. As shown in FIG. 4, the object 102 has a first side 102a and a second side 102b, which is opposite to the first side 102a. The fixing mechanism 100 of the present embodiment includes a first clamping structure 104, a first positioning pillar 106, a first buffering structure 108 and a fixing structure 110. The first clamping structure 104 is connected to the first side 102a of the object 102, and the first positioning pillar 106 is connected to the case 112. The first buffering structure 108 is used for connecting the first clamping structure 104 to the first positioning pillar 106, so that the first side 102a of the object 102 is connected to the case 112. In addition, the fixing structure 110 is used for connecting the second side 102b of the object 102 to the case 112. In this embodiment, the fixing structure 110 includes a second clamping structure 114, a second positioning pillar 116 and a second buffering structure 118. The second clamping structure 114 is connected to the second side 102b of the object 102, and the second positioning pillar 116 is connected to the case 112. The second buffering structure 118 is used for fixing the second clamping structure 114 to the second positioning pillar 116, and thereby, the object 102 is connected to the case 112.

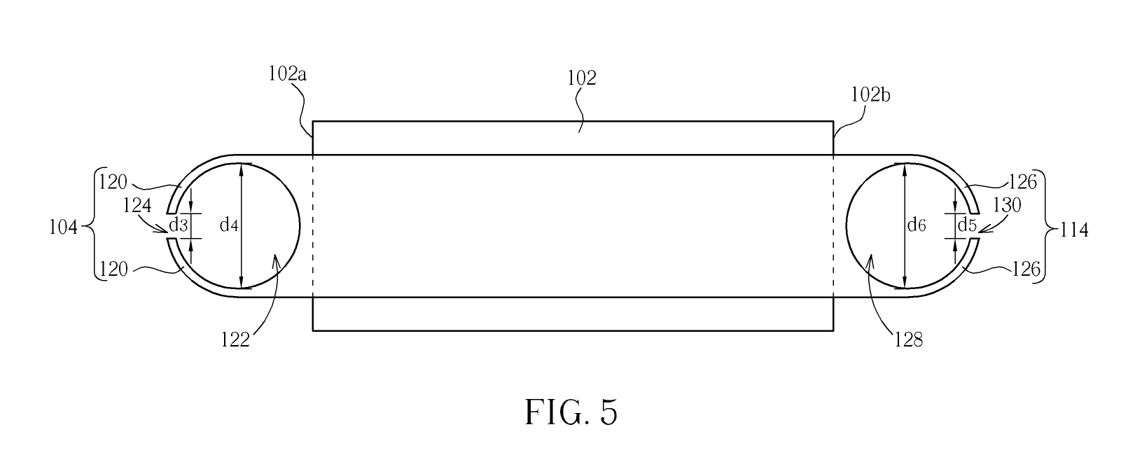

FIG. 5 illustrates the details of the first clamping structure and the second clamping structure. Please refer to FIG. 5, which illustrates a top view of the object with the first clamping structure and the second clamping structure of the first embodiment. As shown in FIG. 5, the first clamping structure 104 has two first clamping arms 120 to clamp the first buffering structure 108 therebetween, and each first clamping arm 120 extends outward from the first side 102a of the object 102, so that the first clamping structure 104 is provided with a first through hole 122 disposed between the first clamping arms 120. One end of each first clamping arm 120 is connected to the object 102 and the other ends of the first clamping arms 120 are not connected to each other but have a first opening 124. The width d3 of the first opening 124 is less than or equal to the hole diameter d4 of the first through hole 122. The second clamping structure 114 also has two second clamping arms 126, and each second clamping arm 126 extends outward from the second side 102b of the object 102, so that the second clamping structure 114 is provided with a second through hole 128 disposed between the second clamping arms 126. One end of each second clamping arm 126 is connected to the object 102 and the other ends of the second clamping arms 126 are not connected to each other but have a second opening 130. The width d5 of the second opening 130 is less than or equal to the hole diameter d6 of the second through hole 128. In addition, the first clamping structure 104, the second clamping structure 114, and the object 102 are formed integrally, but they are not limited to this. In order to connect the object 102 to the case 112, the first clamping structure 104 and the second clamping structure 114 are made of a material with a certain rigidity, such as a plastic material or a metal material, but they are not limited to this.

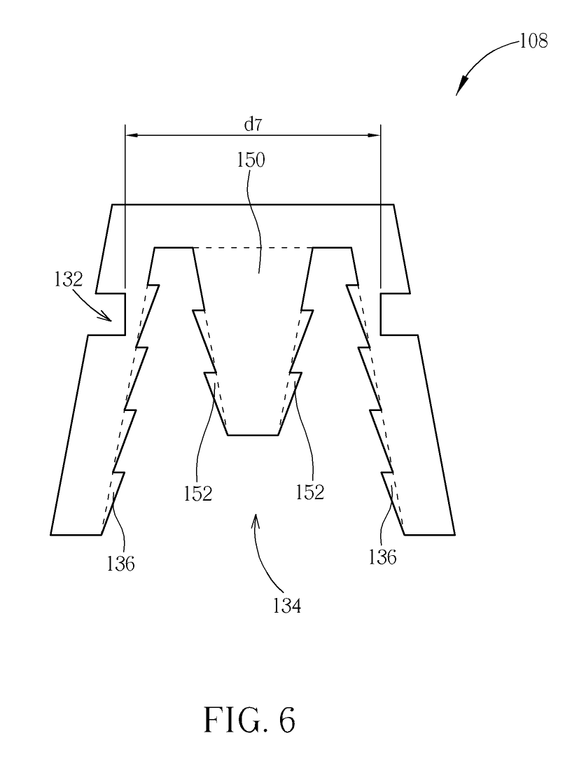

Please refer to FIG. 4, FIG. 5 and FIG. 6. FIG. 6 illustrates an example of a cross section of the first buffering structure according to the first embodiment of the present invention. Only the first buffering structure is taken for illustration because the first buffering structure and the second buffering structure have similar structure. As shown in FIG. 4, FIG. 5 and FIG. 6, the first buffering structure 108 is provided with a first positioning hole 134 and has a first trench 132. The first trench 132 surrounds a sidewall of the first buffering structure 108, so that it becomes an annular trench. The diameter d7 of the first buffering structure 108 within the first trench 132 roughly equals the hole diameter d4 of the first through hole 122, and the cross-sectional area of the first buffering structure 108 outside of the first trench 132 and parallel with the first trench 132 is larger than the area of the first through hole 122, so that the first through hole 122 of the first clamping structure 104 may engage with the first trench 132 to fasten the first side 102a of the object 102 on the first buffering structure 108. In addition, the first positioning hole 134 is disposed on a bottom surface of the first buffering structure 108, a region surrounded by the bottom surface of the first buffering structure 108. The first positioning hole 134 is used for engaging the top of the first positioning pillar 106. In addition, the first buffering structure 108 further includes a plurality of first protruding parts 136 located on an annular sidewall of the first positioning hole 134. In this embodiment, each first protruding part 136 may be in a form of an annular structure, encircling the annular sidewall of the first positioning hole 134, but they are not limited to this. The first protruding parts 136 of the present invention may be in a form of bumps, too, and provided on the annular sidewall of the first positioning hole 134. Or, each first protruding part 136 may be in a form of a barb to provide greater friction with respect to the first positioning pillar 106. The first protruding parts 136 of the present invention are not limited to barbs, and may also be in other geometric forms to be resilient and compressible, so that the first protruding parts 136 may be compressed to generate a greater frictional force to be able to engage with the first positioning pillar 106. Please note that the first buffering structure 108 of the present invention is made of a buffering material, such as rubber, but it is not limited to this. As a result, when the first positioning pillar 106 is inserted into the first positioning hole 134, the first protruding parts 136 engage with the first positioning pillar 106 due to the presence of a frictional force so that the first positioning pillar 106 is fixed in the first positioning hole 134, to more effectively fix the first buffering structure 108 to the first positioning pillar 106.

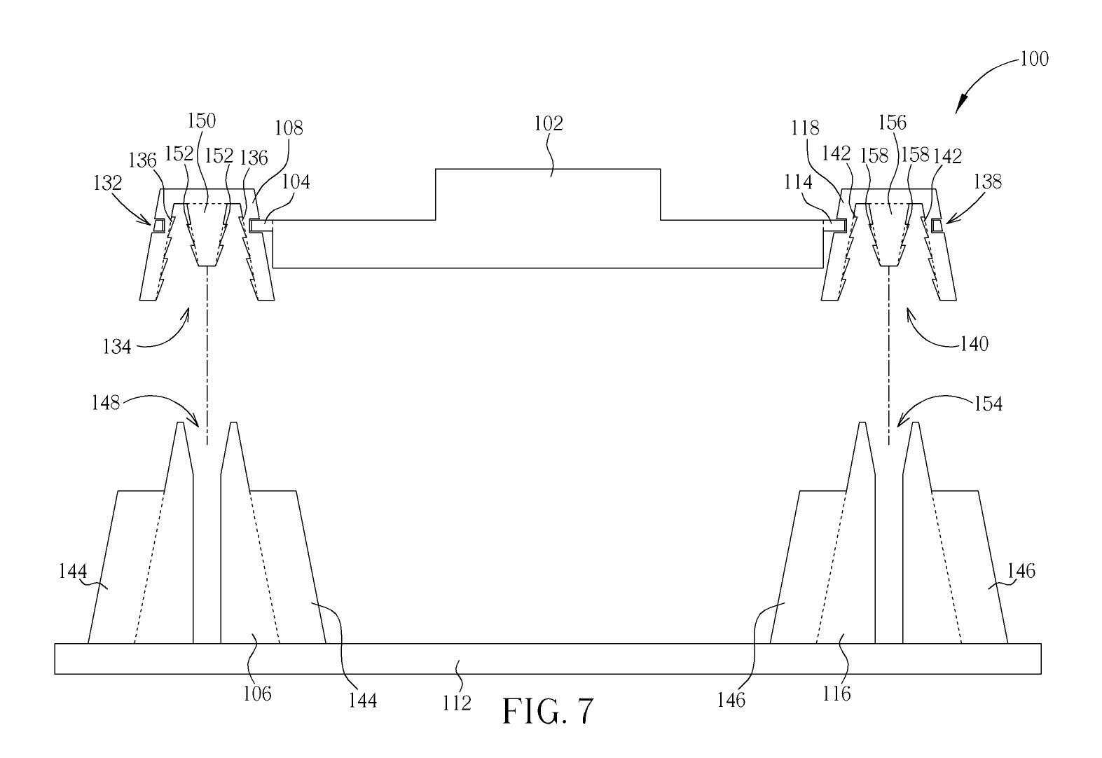

Please refer to FIG. 7 with reference to FIG. 4 and FIG. 6. FIG. 7 is a section view of the fixing mechanism in FIG. 4 along line A-A′. As shown in FIG. 6 and FIG. 7, similar to the first buffering structure 108, the second buffering structure 118 is provided with a second positioning hole 140 and has a second trench 138 surrounding a sidewall of the second buffering structure 118 and a plurality of second protruding parts 142. The second through hole 128 of the second clamping structure 114 is engaged with the second trench 138 to fasten the second side of the object 102 on the second buffering structure 118, and the second positioning hole 140 is disposed on a bottom surface of said second buffering structure 118. The second protruding parts 142 are disposed on an annular sidewall of the second positioning hole 140, and the second positioning hole 140 is used for engaging the second positioning pillar 116 and the second protruding parts 142 engaged with the second positioning pillar 116 so that the second buffering structure 118 is fastened to the second positioning pillar 116. The first positioning pillar 106 of this embodiment may be further provided with a first hole 148 located on an upper surface of the first positioning pillar 106. The first buffering structure 108 may further have a first positioning part 150 provided on a bottom of the first positioning hole 134. The first positioning part 150 protrudes from the inner surface of the first positioning hole 134 in the first buffering structure 108 used for inserting into and engaging with the first hole 148 to fasten the first buffering structure 108 to the case 112. In order to effectively engage the first positioning part 150 with the first hole 148, the first buffering structure 108 may further have a plurality of third protruding parts 152, disposed on an annular sidewall of the first positioning part 150. The third protruding parts 152 are also made of a buffering material so that the third protruding parts 152 engage with the first positioning pillar 106 to further fix the first positioning part 150 in the first hole 148. Each third protruding part 152 in this embodiment may also be in a form of a barb, but it is not limited to this. Also, the second positioning pillar 116 of this embodiment may be further provided with a second hole 154. The second buffering structure 118 may further have a second positioning part 156 protruding from the inner surface of the second buffering structure 118 and a plurality of fourth protruding parts 158. And, the first positioning pillar 106, the second positioning pillar 116 and the case 112 in this embodiment are integrally formed. The first positioning pillar 106, the second positioning pillar 116 and the case 112 are made of a material with a certain rigidity, such as a plastic material, but they are not limited to this. The first positioning pillar 106, the second positioning pillar 116 and the case 112 are not limited to being integrally formed. In addition, in order to fix the first buffering structure 108 and the second buffering structure 118 which are fixed to the object 102 to the first positioning pillar 106 and the second positioning pillar 116, the distance between the first positioning pillar 106 and the second positioning pillar 116 is designed in accordance with the distance between the first positioning hole 134 and the second positioning hole 140 when the first buffering structure 108 and the second clamping structure 118 are fixed to the object 102, so that the distance between the centers of the first positioning pillar 106 and the second positioning pillar 116 is roughly the same as the distance between the centers of the first positioning hole 134 and the second positioning hole 140.

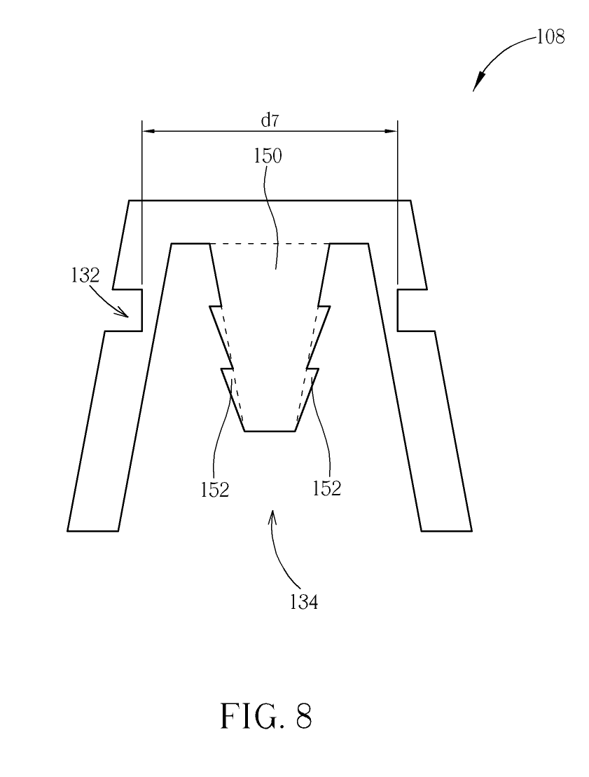

The buffering structure of the present invention is not limited to the protruding parts in the positioning holes. The positioning parts protruding from the bottom of the positioning hole may have protruding parts on their sidewalls. Please refer to FIG. 8, which illustrates another example of the first buffering structure of the fixing mechanism of the first embodiment of the present invention. Referring to FIG. 8, compared with the first buffering structure of the previous embodiments, the first buffering structure 108 of this example is disposed in the first positioning hole 134 and has no protruding parts. In other words, in addition to the first trench 132 and the first positioning hole 134, the first buffering structure 108 of this example has the first positioning part 150 and the third protruding parts 152. The first positioning part 150 protrudes from the bottom of the first positioning hole 134 and is used for inserting into the hole 148 of the first positioning pillar 106. The third protruding parts 152 are disposed on the sidewall of the first positioning part 150. Please note that the third protruding parts 152 engage with the first hole 148 of the first positioning pillar 106 so that the first buffering structure 108 is fixed to the first positioning pillar 106 and the first buffering structure 108 is fastened to the case 112.

Please refer to FIG. 4. The fixing mechanism 100 of the present invention further includes four first reinforcing ribs 144, and each first reinforcing rib 144 is connected to a sidewall of the case 112 and the sidewall of the first positioning pillar 106 to strengthen the first positioning pillar 106 connected to the case 112, so that the first positioning pillar 106 is firmly connected to the case 112. Each first reinforcing rib 144 is respectively disposed in a direction normal to adjacent reinforcing ribs 144, so that the first positioning pillar 106 is evenly reinforced with respect to all directions of the case 112. Please note that the height of the first reinforcing rib 144 is less than that of the first positioning pillar 106, so that each first reinforcing rib 144 may be used to position the depth of the first positioning pillar 106 inserted in the first buffering structure 108. When the first positioning pillar 106 is inserted in the first positioning hole of the first buffering structure 108, the bottom of the first buffering structure 108 stays against each first reinforcing rib 144 to position the depth of the first positioning pillar 106 inserted in the first buffering structure 108. Similarly, the fixing mechanism 100 also further includes four second reinforcing ribs 146, each connected to the case 112 and the sidewall of the first positioning pillar 106. The functions and the structures of the second reinforcing ribs 146 are similar to those of the first reinforcing rib 144 so the details will not be described again. Quantity of the first reinforcing ribs 144 and the second reinforcing ribs 146 is not limited to four, and can be adjusted in accordance with the scenario when the present invention is practiced.

Please continue to refer to FIG. 4 and FIG. 7, which further illustrate the way how the fixing mechanism of the present invention is combined. First, an external force is applied to the two first clamping arms 120 of the first clamping structure 104, so an outward elastic deformation of the first clamping arms 120 is caused to widen the first opening 124. The first trench 132 of the first buffering structure 108 is placed between the two first clamping arms 120 in a direction normal to the first through hole 122 by means of the elastic material of the first buffering structure 108, so that the first clamping arms 120 are engaged within the first trench 132, and the first buffering structure 108 is fixed between the clamping arms 120 by the help of the elastic recovery force of the first clamping arms 120. Also, the first buffering structure 108 may be compressed to go through the first through hole 122 of the two first clamping arms 120, then the first buffering structure 108 is engaged within the first trench 132 after the elastic recovery of the first buffering structure 108 is regained. For the same reason, the second buffering structure 108 can be fixed between the two second clamping arms 126 of the second clamping structure 114 in a similar way. Next, the first positioning part 150 and the second positioning part 156 are respectively inserted into the first hole 148 and the second hole 154. With the engagement of the first protruding parts 136, the second protruding parts 142, the third protruding parts 152 and the fourth protruding parts 158, as well as the first positioning part 150 and the second positioning part 156, the first buffering structure 108 and the second buffering structure 118 are respectively fixed on the first positioning pillar 106 and the second positioning pillar 116. Please note that the first buffering structure 108 and the second buffering structure 118 made of a buffering material are used to connect the object 102 to the case 112. In such a way, the object 102 is connected to the case 112. If the object 102 is a vibrating device, such as a speaker, the first buffering structure 108 and the second buffering structure 118 absorb the vibration coming from the object 102 without passing it to the case 112 and solve the problem of resonance of the case 112. In addition, compared with the screw solution, the fixing mechanism 100 of the present invention makes the first buffering structure 108 and the second buffering structure 118 engage within the first clamping structure 104 and the second clamping structure 114, and fixes the first buffering structure 108 and the second buffering structure 118 on the first positioning pillar 106 and the second positioning pillar 116 to save time for assembling the mechanism. Further, no additional tool is needed for assembling the fixing mechanism 100, so no screws are needed and time for using a screwdriver to assemble the mechanism is saved.

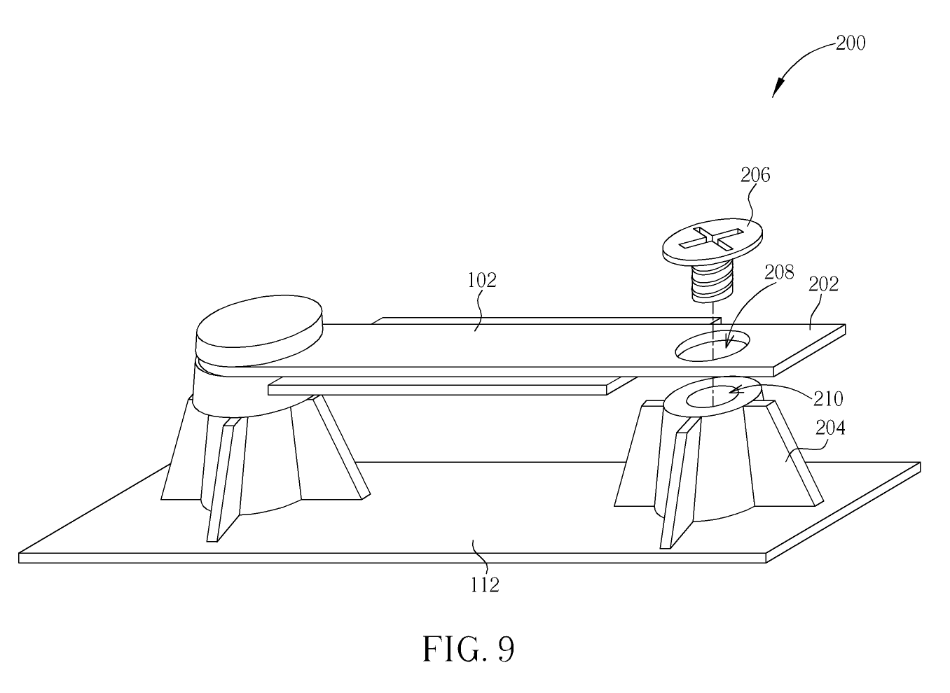

In addition, the fixing structure for fastening the second side of the object is not necessarily the same as the fixing structure for fastening the first side of the object, but may have another configuration. Please refer to FIG. 9, which illustrates a side view of a fixing mechanism according to a second embodiment of the present invention. The same elements or parts in the first and second embodiment share the same reference numerals and the same details will not described again. As shown in FIG. 9, compared with the first embodiment, the fixing structure 110 in the fixing mechanism 200 in the second embodiment includes a first fixing hole part 202, a second fixing hole part 204, and a fixing part 206. The first fixing hole part 202 is provided with a third through hole 208 and is connected to the second side 102b of the object 102. The second fixing hole part 204 is provided a third hole 210 and is connected to the case 112. In this embodiment, the second side 102b of the object 102 uses the fixing part 206 to fix the first fixing hole part 202 to the second fixing hole part 204 so as to lock the second side 102b of the object 102 to the case 112. In addition, the first clamping structure 104, the first positioning pillar 106, and the first buffering structure 108 in the fixing mechanism 200 of this embodiment are the same as the first clamping structure, the first positioning pillar, and the first buffering structure in the first embodiment.

The present invention fixes a buffering structure made of a buffering material to at least one side of the object, and forms a positioning hole disposed on a bottom surface of the buffering structure, so that the positioning pillar on the case may be inserted into the positioning hole and fix the buffering structure to the positioning pillar by means of protruding parts. In such a way, the object is fixed to the case, and if the object is a device which vibrates, the buffering structure absorbs the vibration coming from the object without passing it to the case to solve the problem of resonance of the case, and the present invention also prevents the object from coming off of the case due to its vibration.

Those skilled in the art will readily observe that numerous modifications and alterations of the device and method may be made while retaining the teachings of the invention.

What is claimed is:

1. A fixing mechanism, used to fasten an object with a first side and a second side on a case, comprising:
a first clamping structure provided with a first through hole and connected to said first side of said object;
a first positioning pillar connected to said case;
a first buffering structure provided with a first positioning hole and having a first trench and a plurality of first protruding parts, said first trench surrounding a sidewall of said first buffering structure so that said first through hole of said first clamping structure is engaged with said first trench to fasten said first side of said object on said first buffering structure, said first positioning hole disposed on a bottom surface of said first buffering structure, and a plurality of said first protruding parts disposed on a sidewall of said first positioning hole, said first positioning hole used for engaging said first positioning pillar and a plurality of said first protruding parts engaged with said first positioning pillar; and
a fixing structure for fastening said second side of said object on said case.

2. The fixing mechanism of claim 1, wherein said fixing structure comprises:
a first fixing hole part connected to said second side of said object;
a second fixing hole part connected to said case; and
a fixing part for fixing said first fixing hole part to said second fixing hole part.

3. The fixing mechanism of claim 1, wherein said fixing structure comprises:
a second clamping structure provided with a second through hole and connected to said second side of said object;
a second positioning pillar connected to said case; and
a second buffering structure provided with a second positioning hole and having a second trench and a plurality of second protruding parts, said second trench surrounding a sidewall of said second buffering structure so that said second through hole of said second clamping structure is engaged with said second trench to fasten said second side of said object on said second buffering structure, said second positioning hole disposed on a bottom surface of said second buffering structure, and a plurality of said second protruding parts disposed on a sidewall of said second positioning hole, said second positioning hole used for engaging said second positioning pillar and a plurality of said second protruding parts engaged with said second positioning pillar so that said second buffering structure is fastened to said second positioning pillar.

4. The fixing mechanism of claim 1, wherein said first buffering structure is made of a buffering material so that a plurality of said first protruding parts are engaged with said first positioning pillar.

5. The fixing mechanism of claim 4, wherein said buffering material is rubber.

6. The fixing mechanism of claim 1, wherein each of said first protruding parts is in a form of a barb.

7. The fixing mechanism of claim 1, wherein said first positioning pillar is provided with a hole and said first buffering structure has a positioning part protruding from a bottom of said first positioning hole used for inserting into said hole to fasten said first buffering structure to said case.

8. The fixing mechanism of claim 7, wherein said first buffering structure further comprises a plurality of third protruding parts disposed on a sidewall of said positioning part.

9. The fixing mechanism of claim 8, wherein each of said third protruding parts is in a form of a barb.

10. The fixing mechanism of claim 1, wherein said first clamping structure comprises two clamping arms to clamp said first buffering structure therebetween.

11. The fixing mechanism of claim 10, wherein said clamping arms have an opening and the width of said opening is less than or equal to the diameter of said first through hole.

12. The fixing mechanism of claim 11, wherein the diameter of said first through hole is substantially equal to the diameter of said first buffering structure in said first trench.

13. The fixing mechanism of claim 12, wherein a cross-sectional area of said first buffering structure outside of said first trench and parallel with said first trench is larger than an area of said first through hole.

14. The fixing mechanism of claim 1, further comprising:
at least one reinforcing rib connected to a sidewall of said case.

15. A fixing mechanism, used to fasten an object with a first side and a second side on a case, comprising:
a first clamping structure provided with a first through hole and connected to said first side of said object;
a first positioning pillar provided with a hole and connected to said case;
a first buffering structure provided with a first positioning hole and having a first trench, said first trench surrounding a sidewall of said first buffering structure so that said first through hole of said first clamping structure is engaged with said first trench to fasten said first side of said object on said first buffering structure, said first buffering structure further comprising a positioning part protruding from a bottom of said first positioning hole and for inserting into said hole of said first positioning pillar and a plurality of third protruding parts disposed on a sidewall of said positioning part to engage with said hole of said first positioning pillar so that said first buffering structure is fastened to said first positioning pillar to fasten said first buffering structure to said object; and
a fixing structure for fastening said second side of said object on said case.
